(19) United States
(12) Patent Application Publication
(10) Pub. No.: US 2008/0180214 A1
(43) Pub. Date: Jul. 31, 2008

(54) Protective pager sleeve

(75) Inventors: Thor Halseth, Agoura Hills, CA (US); Jack Osborne, Sea Isle City, NJ (US)

Correspondence Address: SANDRA LEE LIPKIN;A LAW CORPORATION, 1891 GOODYEAR AVE., SUITE 622, VENTURA, CA, 93003, US

(73) Assignee: S2S Design

(21) Appl. No.: 11/980,219

(22) Filed: Oct. 29, 2007

Related U.S. Application Data
(60) Provisional application No. 60/898,017, filed on Jan. 26, 2007.

(51) Int. Cl. G08B 5/22; H04Q 1/30

(52) U.S. Cl. 340/7.63

(57) ABSTRACT

A protective cover for pagers of the type used in by establishments wherein those to be served must wait and be notified when their wait is over. The cover is designed to protect the waiting party from bacteria, viruses, germs and the like that may be transferred from waiting party to waiting party as the pager is reused by the establishment. One embodiment is a simple envelope-type sleeve for the pager while a second embodiment is a flat, foldable and sealable cover that quickly wraps around the pager. Optionally, the protective sleeve may be further fortified with anti-bacterial or other hygienic agents.

### REFERENCE TO PRIOR APPLICATION

This application claims the priority of provisional application 60/898,017, filed Jan. 26, 2007 entitled PROTECTIVE PAGER SLEEVE by Thor Halseth and erroneously omitted inventor Jack Osborne.

### BACKGROUND OF THE INVENTION

1. Field of the Invention

The present invention relates generally to the field of protective sleeves, and more particularly to a disposable and/or reusable sleeve that surrounds a remote pager of the type used in any setting wherein there is a wait and the waiting party is given a pager to alert them when their wait is over, the sleeve being designed to protect the waiting party from the transfer of bacteria, viruses, germs and the like.

2. Description of the Prior Art

Pagers are being used more and more to alert waiting parties when their wait for service is over. Some examples of settings where it is found that pagers are given to waiting parties include restaurants, hospitals, car rental places and the like.

More and more it is seen that during this wait time, the waiting party is typically handling the pager with his or her bare hands. Currently, there is not way to protect the waiting party from any microbes, bacteria, viruses or other germs that may have been left on the pager by any previous waiting parties handling that pager. This problem can be exacerbated when the waiting party travels to the common restrooms with the pager. Each waiting party must rely on the good hygiene of previous waiting parties to insure that he or she is not exposed to unwanted germs, which is not very reassuring to an increasingly health-minded public.

To protect waiting parties from the transmission of unwanted germs, it would be desirable to provide a protective barrier between the pager and the waiting party. Prior art in the field has not addressed this problem. Rather, the prior art in the field of protective covers for pagers has either been for the protection of the pager itself from damage or for pure ornamentation purposes. (See U.S. Pat. Nos. 6,123,240 to Fowles et al.; 5,984,103 to Stirmel et al.; 5,598,926 to Vogt; 5,562,223 to Kuroda; 4,901,852 to King; and 3,996,581 to Brodeur et al.)

### SUMMARY OF THE INVENTION

The preferred embodiment of the present invention teaches a protective cover for a pager that protects waiting parties from the unwanted transmission of germs and the like comprising a base portion of sufficient size upon which to place the pager; a top portion of sufficient size to cover the pager; two or more sidewalls connecting the base portion to the top portion and of sufficient height to create a space to house the pager that combined with the base portion and the top portion creates an interior portion of the cover for placement therein of the pager; securing means that secures the pager in the interior portion of the protective cover.

The embodiment above can be further modified by defining that there is a flap that extends from the base portion that wraps around the pager for securing the pager in the cover.

The embodiment above can be further modified by defining that the securing means is an aperture in the top portion of the cover for placement therein of a raised peg on a top side of the pager.

The embodiment above can be further modified by defining that the securing means is an adhesive strip attached to the flap.

The embodiment above can be further modified by defining that the securing means is a hook and loop system that cooperates the top portion of the cover with the flap.

The embodiment above can be further modified by defining that the securing means is a snap that cooperates the top portion of the cover with the flap.

The embodiment above can be further modified by defining that the securing means is a button and button hole that cooperates the top portion of the cover with the flap.

The embodiment above can be further modified by defining that the securing means is a zipper that cooperates the top portion of the cover with the flap.

The embodiment above can be further modified by defining that the securing means is an adhesive sticker upon which promotional material can be placed.

The embodiment above can be further modified by defining that the cover is coated with an anti-bacterial of other hygienic agent.

The embodiment above can be further modified by defining that the top portion has a transparent window through which promotional media placed on a top portion of the pager can be viewed.

The embodiment above can be further modified by defining that the base portion contains promotional material.

The embodiment above can be further modified by defining that the cover is made of a material from the following group: plastic, paper, polypropylene, and cardboard.

The embodiment above can be further modified by defining that the sidewalls are gussets that can flatten the cover when not in use.

A second embodiment defines a protective cover for a pager to protect waiting parties from the unwanted transmission of germs and the like comprising a base portion of sufficient size upon which to place a pager; two or more flaps extending from the base portion wherein the flaps are foldable around the pager and each other; and wherein the flaps have a securing means for securing the cover around the pager.

The embodiment above can be further modified by defining that the said securing means is an adhesive strip attached to one or more of the flaps.

The embodiment above can be further modified by defining that the securing means is a hook and loop system that cooperates with the flaps.

The embodiment above can be further modified by defining that the securing means is a snap that cooperates with the flaps.

The embodiment above can be further modified by defining that the securing means is a button and button hole that cooperates with the flaps.

The embodiment above can be further modified by defining that the said securing means is a zipper that cooperates with the flaps.

The embodiment above can be further modified by defining that the cover is coated with an anti-bacterial or other hygienic agent.

The embodiment above can be further modified by defining that the base portion contains promotional material.

The embodiment above can be further modified by defining that the cover is made of a material from the following group: plastic, paper, polypropylene, and cardboard.

### BRIEF DESCRIPTION OF THE DRAWINGS

FIG. 1 is perspective view of the invention in its first embodiment of the invention prior to the pager being placed inside the protective cover.

FIG. 2 is a perspective view of the first embodiment of the invention with the pager secured inside of the protective sleeve.

FIG. 3 is a perspective view of the second embodiment of the invention prior to the sleeve being wrapped around a pager.

FIG. 4 is a perspective view of the second embodiment of the invention after the sleeve envelopes the pager.

FIG. 5 is an alternate embodiment of the invention showing a cover with gussets allowing for flat storage when not in use.

FIG. 6 is a view of the embodiment shown in FIG. 5 wherein the sleeve is unfolded into a position into which a pager can placed therein.

FIG. 7 is taken along line 7 in FIG. 6 magnifying the optional flap for enclosing a pager in the sleeve.

FIG. 8 shows a pager being place in the embodiment shown in FIG. 5.

FIG. 9 is a view of FIG. 8 with the optional flap being folded over the pager once enclosed inside the sleeve.

FIG. 10 is a perspective view of an alternate embodiment wherein there is no flap and the pager is held in place by a peg on the pager and any advertising media on the top surface of the pager is visible through a transparent window on the top of the sleeve.

### DETAILED DESCRIPTION OF A PREFERRED EMBODIMENT

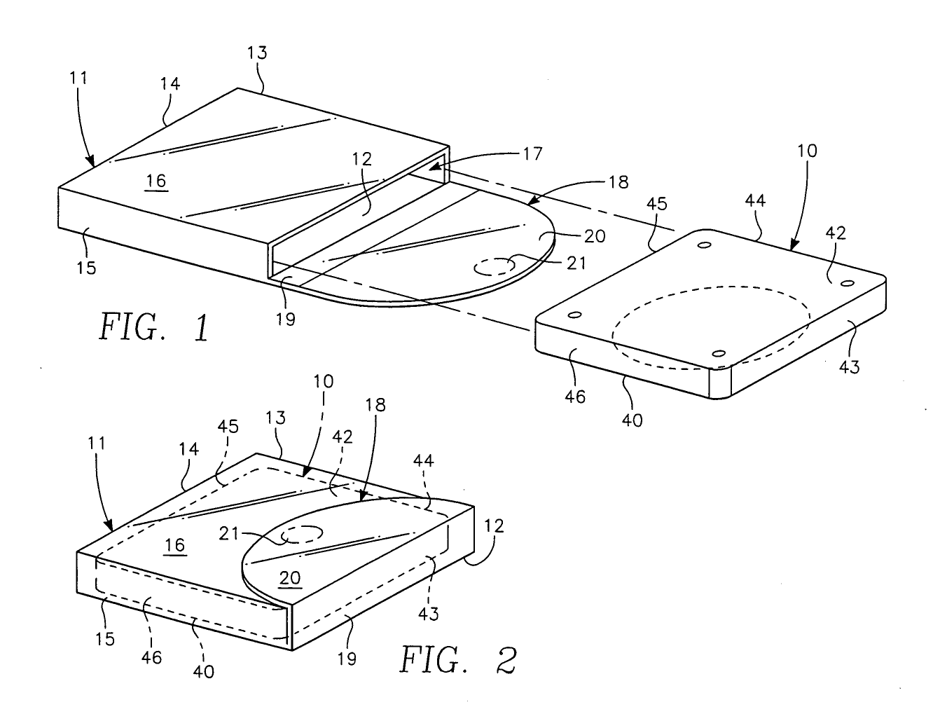

The preferred embodiment of the invention is illustrated in the attached figures. FIG. 1 shows the first embodiment of the instant invention. The invention involves a protective system for pagers 10 given to person who must be alerted when their wait for some service has ended. The pager has a top side 40, a bottom side 42 and four sidewalls 43, 44, 45, 46. Prior to giving the pager 10 to the waiting party, the service establishment worker places the pager 10 with its top side 40 facing the flap 18 of the protective sleeve 11. In the first embodiment, this protective sleeve 11 has a base portion 12, three sidewalls 13, 14, 15, a top portion 16 and an open portion 17, which is where a fourth sidewall 19 will be after the protective sleeve 11 is an enclosed box (as seen in FIG. 2).

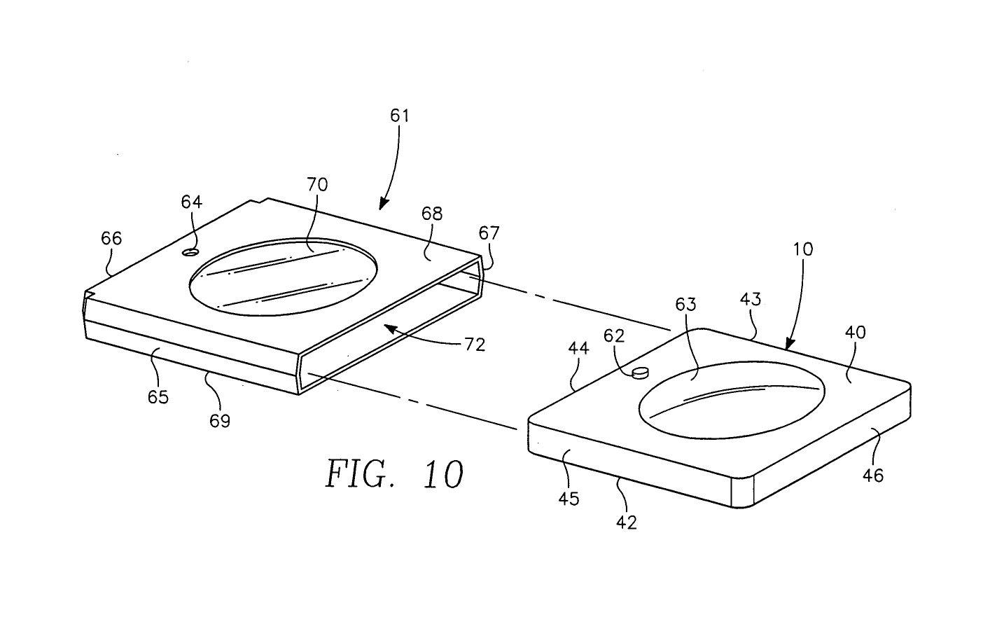

The flap 18 (which may or may not be used) can be attached to the bottom portion 12 of the sleeve 11 as seen in FIG. 10. When the flap 18 is used, once the pager 10 is placed inside of the sleeve 11 (see FIG. 2), the flap 18 is folded over the open portion 17 creating a fourth sidewall 19. The folded over portion 20 of the flap 18 is secured to the top portion 16 of the protective sleeve 11 through a securing means 21 that can be a snap, an adhesive strip, a button, a hook and loop, zipper or other means. Alternatively, an adhesive sticker (not shown) can be placed over the flap 18 to secure it to the sleeve 11 that can contain promotional material, such as specials or coupons offered by the service establishment or offered by a third party establishment.

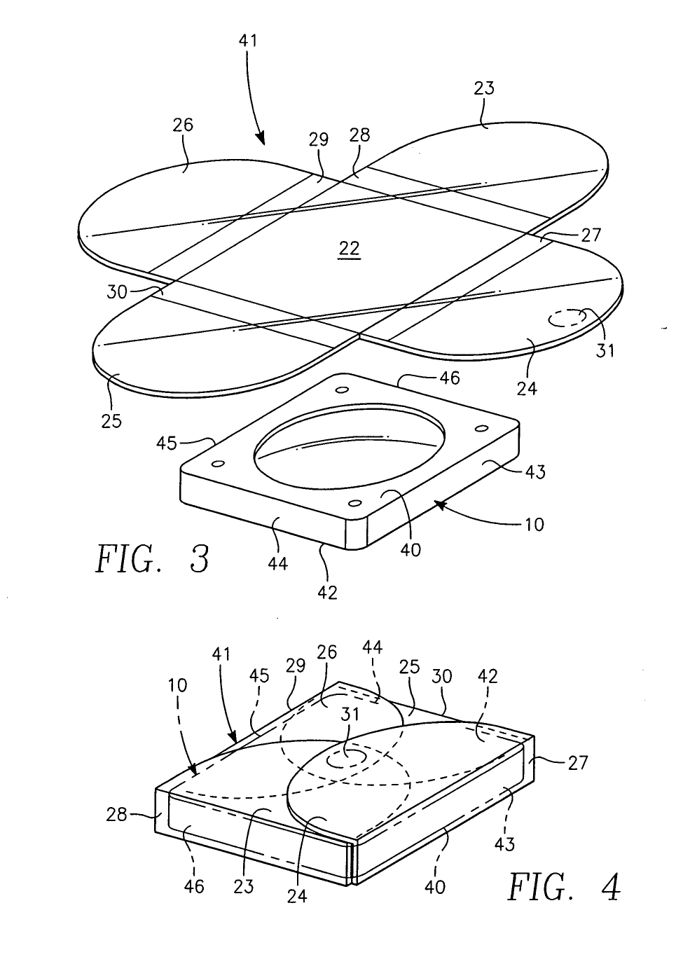

A second embodiment of the invention is illustrated in FIGS. 3 and 4. In this embodiment, the protective sleeve 41 lies flat for easy access by the service establishment prior to use and for easy storage of a quantity of the sleeves 41. The sleeve 41 is placed on the top portion 40 of the pager 10 as shown in FIG. 3 with the center base portion 22 of the sleeve 41 centered over the top portion 40 of the pager 10. Then the flaps 23, 24, 25, 26 are folded over the pager 10. Once placed on the pager 10, the four flaps 23, 24, 25, 26 extending from the center base portion 22 can then be wrapped around the pager 10. Once wrapped around the pager 10, the flaps create four sidewalls 27, 28, 29, 30 that surround the pager 10.

A securing means 31 is located on one or more of the flaps 24 that can be a snap, an adhesive strip, a button, a hook and loop, zipper or other means. In either embodiment, the protective sleeve can be disposable. Also, the material can be infused with an anti-bacterial or other hygienic agent.

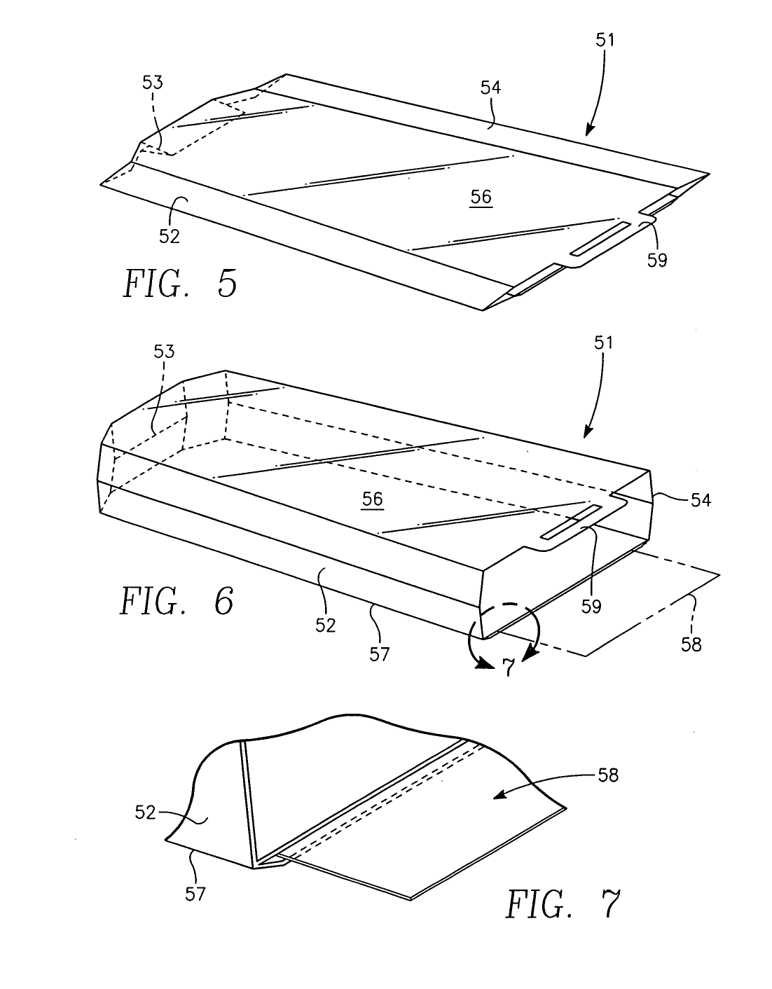

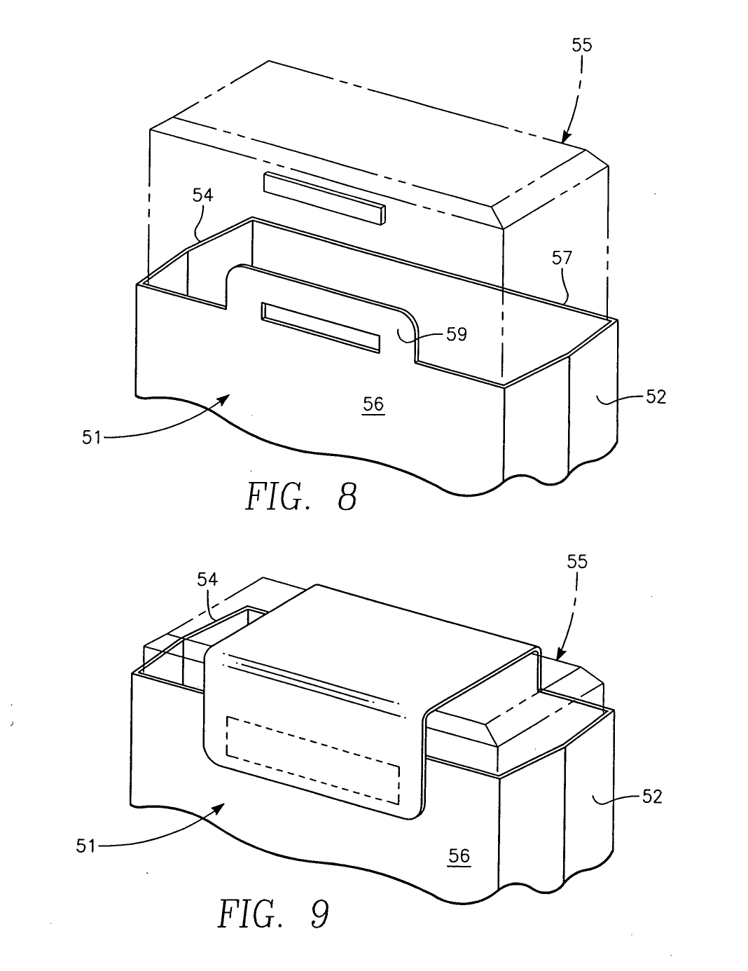

Alternatively, a sleeve 51 can contain gussets for sidewalls 52, 53, 54. The gussets can either fold inward of outward allowing the sleeve 51 to lie flat. This alternative embodiment is illustrated in FIGS. 5-9. This illustration shows a sleeve 51 that is designed to fit around a pager 55 with a shape typically used by hospitals. The sleeve 51 has a top portion 56 and a bottom portion 57 in addition to the side gussets 52, 53, 54. An optional flap 58 can be attached to the bottom portion 57 that extends around the pager 55 and is secured to a connecting portion 59 that is attached to the top portion 56.

Yet another embodiment is shown in FIG. 10. As seen in this illustration, a typical pager 10 has at least one peg 62 on the top portion 40 of the pager 10. Additionally, there is often promotional media 63 can be found on the top portion 40 of the pager 10. This embodiment provides a sleeve 61 that has an aperture 64 in the top portion 68 that receives the pager peg 62 for securing the pager 10 in the sleeve 61. As illustrated in FIG. 10, the sleeve 61 has three gusset sidewalls 65, 66, 67, a top portion 68 and a bottom portion 69. An opening 70 is created when the gussets 65, 66, 67 are unflattened. Furthermore, there is an optional transparent window in the top portion 68 of the sleeve 61 that allows for viewing of the promotional media 63 found on the top portion 40 of the pager 10.

Also disclosed herein, but not shown in the illustrations is the option to place promotional material, such as specials or coupons of the service establishment or a third party establishment on the bottom portion 69 of the sleeve 61. Once the sleeve 61 is removed from the pager 10, typically ripping the pager 10 at the site of the peg 62, such promotional material on the bottom portion 69 of the sleeve provides an incentive for the waiting party to return to the establishment or patronize a third party establishment that compensates the original establishment for placement of the promotional material thereon.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

What is claimed is:

1. A protective cover for a pager to protect waiting parties from the unwanted transmission of germs and the like comprising
a base portion of sufficient size upon which to place said pager;
a top portion of sufficient size to cover said pager;
two or more sidewalls connecting said base portion to said top portion and of sufficient height to create a space to house said pager that combined with said base portion and said top portion creates an interior portion of said cover for placement therein of said pager;
securing means that secures said pager in said interior portion of said protective cover.

2. A protective cover as defined in claim 1 wherein there is a flap that extends from said base portion that wraps around said pager for securing said pager in said cover.

3. A protective cover as defined in claim 1 wherein said securing means is an aperture in said top portion of said cover for placement therein of a raised peg on a top side of said pager.

4. A protective cover as defined in claim 2 wherein said securing means is an adhesive strip attached to said flap.

5. A protective cover as defined in claim 2 wherein said securing means is a hook and loop system that cooperates said top portion of said cover with said flap.

6. A protective cover as defined in claim 2 wherein said securing means is a snap that cooperates said top portion of said cover with said flap.

7. A protective cover as defined in claim 2 wherein said securing means is a button and button hole that cooperates said top portion of said cover with said flap.

8. A protective cover as defined in claim 2 wherein said securing means is a zipper that cooperates said top portion of said cover with said flap.

9. A protective cover as defined in claim 2 wherein said securing means is an adhesive sticker upon which promotional material can be placed.

10. A protective cover as defined in claim 1 wherein the said cover is coated with an anti-bacterial of other hygienic agent.

11. A protective cover as defined in claim 1 wherein said top portion has a transparent window through which promotional media placed on a top portion of said pager can be viewed.

12. A protective cover as defined in claim 1 wherein said base portion contains promotional material.

13. A protective cover as defined in claim 1 wherein said cover is made of a material from the following group: plastic, paper, polypropylene, and cardboard.

14. A protective cover as defined in claim 1 wherein said sidewalls are gussets that can flatten said cover when not in use.

15. A protective cover for a pager to protect waiting parties from the unwanted transmission of germs and the like comprising
a base portion of sufficient size upon which to place a pager;
two or more flaps extending from said base portion wherein said flaps are foldable around said pager and each other; and wherein said flaps have a securing means for securing said cover around said pager.

16. A protective cover as defined in claim 15 wherein said securing means is an adhesive strip attached to one or more of said flaps.

17. A protective cover as defined in claim 15 wherein said securing means is a hook and loop system that cooperates with said flaps.

18. A protective cover as defined in claim 15 wherein said securing means is a snap that cooperates with said flaps.

19. A protective cover as defined in claim 15 wherein said securing means is a button and button hole that cooperates with said flaps.

20. A protective cover as defined in claim 15 wherein said securing means is a zipper that cooperates with said flaps.

21. A protective cover as defined in claim 15 wherein said cover is coated with an anti-bacterial or other hygienic agent.

22. A protective cover as defined in claim 15 wherein said base portion contains promotional material.

23. A protective cover as defined in claim 15 wherein said cover is made of a material from the following group: plastic, paper, polypropylene, and cardboard.
